(19) United States
(12) Patent Application Publication
(10) Pub. No.: US 2025/0094377 A1
(43) Pub. Date: Mar. 20, 2025

(54) DEVICE, ESPECIALLY INPUT DEVICE, AND METHOD FOR CHANGING THE CONTROLLING UNIT FOR DATA TRANSMISSION

(71) Applicant: Christoph HELDEIS, München (DE)

(72) Inventor: Christoph HELDEIS, München (DE)

(21) Appl. No.: 18/727,900

(22) PCT Filed: Jan. 10, 2022
(86) PCT No.: PCT/EP2022/050352

§ 371 Date: Jul. 10, 2024

(51) Int. Cl. G06F 13/42; G06F 13/28; G06F 13/38; H04W 4/38

(52) U.S. Cl. CPC G06F 13/4291; G06F 13/28; G06F 13/385; H04W 4/38

(57) ABSTRACT

Described is a device (100, 200, 400, 500), especially an input device (100 to 400), comprising a sensor (SEN),
wherein the device (500) comprises a first communication unit (CU1, SPI1, I2C1) and a second communication unit (CU2, SPI2, I2C2) that are adapted for synchronous communication according to a clock signal (SCLK, SCL) generated by the first communication unit (CU1, SPI1, I2C1) or the second communication unit (CU2,SPI2, I2C2),
wherein the first communication unit (CU1, SPI1, I2C1) is adapted to send digital data (D2 or D2b) to the second communication unit (CU2, SPI2, I2C2),
wherein the digital data (D2 or D2b) comprises data (D2) generated by the sensor (SEN) or processed data (D2b) derived from data (D2) generated by the sensor (SEN),
wherein the first communication unit (CU1, SPI1, I2C1) is adapted to be used as a controlling unit during the transmission of the digital data (D2 or D2b) during a first operation mode of the communication units (CU1, CU2),
wherein the second communication unit (CU2, SPI2, I2C2) is adapted to be used as a controlled unit during the transmission of the digital data (D2 or D2b) during the first operation mode of the communication units (CU1, CU2), and
wherein the controlling unit generates the clock signal (SCLK, SCL) for the controlled unit.

There are many peripheral devices, e.g. in computer systems, that generate data which has to be transmitted to a more central processing unit. There may be a first communication unit on the side of the peripheral unit. A second communication unit may be used at the side of the more central data processing unit. Data transmission from the periphery to the central unit may be controlled using a supra-ordinated unit, e.g. the communication unit on the side of the more central processing unit. A known principle is a master unit versus secondary unit, where the master unit controls data transmission between the two communication units. The master unit may be the communication unit on the side of the more central data processing unit. Examples for peripheral devices are sensors, e.g. image sensors, mechanical sensors, electromechanical sensors, magnetic sensors, capacitive sensors, etc.

In more detail, the disclosure relates to a peripheral device of a computer system, preferably to a USB device, e.g. especially an input device. Some input devices, for instance a mouse device, a trackball device and a keyboard, are known for decades and other input devices have been developed only recently, for instance electrical input pen (Apple (may be a trademark) pen, stylus pen) and three-dimensional mouse (for instance Space mouse (may be a trademark)).

On one side, there are mainstream applications of input devices. Exemplary, typing a text and/or navigating within a text. On the other side, there are special applications of input devices, for instance in CAD (Computer Aided Design) or Gaming (E-Sport).

It is an object of the invention to provide an improved device, especially an improved input device that allows fast data transfer from the peripheral device to the central processing unit. Furthermore, a corresponding method shall be provided.

This object is solved by the device according to claim 1. Further embodiments are provided in the dependent claims. Furthermore, the above mentioned object is solved by the subject matter of the independent method claim.

According to an embodiment, a device, especially an input device, may comprise a sensor. The device may comprise a case that comprises the units of the device. Alternatively, the device may comprise parts that are detached from each other.

The sensor may be a peripheral unit, e.g. a unit that generates data that has to be transmitted to a more central unit of the device.

The sensor may be a sensor as mentioned above. Furthermore, the sensor may be a switch or key of keyboard, a temperature sensor, an acceleration sensor, a humidity sensor, an optical sensor, e.g. an image sensor comprising several picture elements.

According to an embodiment, the device may comprise a first communication unit and a second communication unit that are adapted for synchronous communication according to a clock signal generated by the first communication unit or by the second communication unit. However, the principles of this disclosure may also be applied to asynchronous data transmission.

The communication may be a serial communication, i.e. one bit of a data word is transmitted after each other. However, the principles of this disclosure may also be applied to parallel data transfer, e.g. to data transfer that transmits at least two bits of a data word or all bits of a data word at the same time.

According to an embodiment, the first communication unit may be adapted to send digital data to the second communication unit. Digital data may be data that comprises only two values per bit, e.g. logical 0 and logical 1. This is contrary to analogue signals that may have a wider range of values of a signal.

According to an embodiment, the digital data may comprise data generated by the sensor or processed data derived from data generated by the sensor. Thus, raw data may be transmitted, e.g. large amounts of raw data. Alternatively, pre-processed data and/or processed data may be transmitted. Pre-processing may comprise filtering without or with reduction of the amount of data. Processing of the data may result in a reduction of the amount of data, e.g. in a reduction of the amount to one half or to less than on half or less than one tenths of the data amount. Furthermore, processing may leave the amount of data unchanged or may even increase the amount of data.

According to an embodiment, the first communication unit may be adapted to be used as a controlling unit during the transmission of the digital data during a first operation mode of the communication units. Thus, there may be special pins and/or there may be other provisions to enable operation as a controlling unit, e.g. as a master unit. Programming of a processor may allow operation as a controlling unit. Establishing the controlling function on the side of the sensor may allow immediate transfer of sensor data, e.g. compared to delayed transfer using polling mechanism where the second communication unit initiates data transfer.

However, there may be other operation modes of the device in which the first communication unit may operate as a controlling unit, e.g. master unit. Switching of the controlling function may also be possible, e.g. based on a predefined criterion, e.g. time-period is over, a predefined number of transmission actions have been taken place, receiving of special control data, etc.

According to an embodiment, the second communication unit may be adapted to be used as a controlled unit during the transmission of the digital data during the first operation mode of the communication units. Thus, there may be special pins and/or there may be other provisions to enable operation as a controlled unit, e.g. as a secondary unit. Programming of a processor may allow operation as a controlled unit.

According to an embodiment, the controlling unit may generate the clock signal for the controlled unit.

Both communication units may be arranged on different semiconductor dies. Thus, the communication may be an inter chip communication that is different from intra chip communication and that has other technical effects.

The device may be a telecommunication device. Alternatively, the device may not be a telecommunication device.

According to an embodiment, the device may comprise a processor that configures or is adapted to configure the first communication unit. The processor may be programmed such that the first communication unit may be used as the controlling unit during the transmission of the digital data, preferably during the first operation mode of the device.

According to an embodiment, the device may comprise a further processor that configures or is adapted to configure the second communication unit. The further processor may be programmed such that the second communication unit is used as the controlled unit during the transmission of the digital data, preferably during the first operation mode of the device. There may be a second operation mode in which the master functionally is changed, e.g. the first communication unit is the secondary unit and the second communication unit is the master unit. Thus, the second operation mode may be an operation mode that is different from the first operation mode.

These embodiments specify what “adapted to” may mean. Additional or alternative means may be used to adapt the communication units to its controlling function or to its controlled function or operation.

According to an embodiment, the device may be an optical input device for detecting input of a user based on movement of the input device relative to a surface or vice versa. The optical input device may comprise a case, an optical unit that comprises the sensor and an electrical unit. The optical unit may comprise a radiation source and the sensor arranged within the case or on the case. The elements of the optical unit may be arranged such that radiation emitted by the radiation sensor may be directed to a surface on which the case of the device is moved by the user and such that radiation that is reflected by the surface is received by the radiation sensor. Other arrangement of these elements may be used as well.

The electrical unit may comprise the first communication unit and the second communication unit arranged within the case. The first communication unit may be adapted to send digital data to the second communication unit. The digital data may comprise data generated by the radiation sensor or processed data derived from data generated by the radiation sensor.

The first communication unit of the optical input device may be adapted to be used as a controlling unit during the transmission of the digital data, e.g. in the first operation mode. The second communication unit of the optical input device may be adapted to be used as a controlled unit during the transmission of the digital data, e.g. in the first operation mode.

Thus, the master and secondary unit (target unit) principle may be applied in the optical input device as well. The communication unit on the side of the optical sensor may be the master unit allowing immediate and fast transfer of senor data, e.g. in gaming applications or other high speed applications.

The radiation may be electromagnetic radiation, e.g. light. The radiation sensor, may be a CMOS (Complementary Metal Oxide Semiconductor) sensor, e.g. compatible with CMOS processes. The CMOS sensor may comprise at least one transistor within each picture element, e.g. a FET (field effect transistor). Thus, high sensitivity may be reached, e.g. below ten photons. Other technical effects of CMOS sensors may be used as well.

Alternatively a CCD (charge coupled device) sensor may be used, e.g. a sensor in which electrical charge is transported within wells from the picture elements to peripheral units of the sensor. The charge may be converted at peripheral units to a voltage signal and/or to a current signal. Thus, electrical units for amplifying of signals may be arranged outside of sensitive sensor field. High resolution may be possible as well as cost effective production.

A sensor for an optical mouse device may have a number of pixels of less than 10000 pixels (picture elements), e.g. of less than 100 pixels by 100 pixels (e.g. quadratic sensor matrix). Alternatively, the sensor for a mouse may have a number of pixels of less than 2500 pixels, e.g. of less than 50 pixels by 50 pixels if a quadratic sensor is used. Moreover the number of pixels may be less than or equal to 1024 pixels, less than or equal to 32 pixels by 32 pixels. Other of sensor matrixes may be used as well, e.g. rectangular or linear sensor fields comprising only one line of picture elements.

The radiation sensor may be sensitive for electromagnetic radiation, e.g. light within the range of 350 nm (nanometer) to 750 nm wave length or infrared light (greater than 750 nm) e.g. up to 1000 nm (1 um (Micrometer)) or up to 1200 nm or ultra violet light, e.g. less than 350 nm and/or down to 100 nm or down to 50 nm.

According to a further embodiment, the device may be a digital camera, e.g. a still image camera or a video camera. The camera may be part of a smart phone or of another device. No radiation source may be necessary in the embodiment relating to a camera.

According to an embodiment, the first communication unit may comprise a first port adapted to output a clock signal used for synchronizing the communication between the first communication unit and the second communication unit, especially during the first operation mode of the device. The second communication unit may comprise a first port electrical connected to the first port of the first communication unit and adapted to receive a clock signal, especially during the first operation mode of the device. The clock signal may be used to synchronize data transfer between the two communication units. The port may be a pin or an electrical node of the electrical circuitry. A voltage may be generated on the port. A current may flow out of the port or into the port.

According to an embodiment, the first communication unit may comprise one or at least one data port adapted to output a data signal used for transmitting the digital data from the first communication unit to the second communication unit. The second communication unit may comprise one or at least one data port adapted to receive the output signal. The port may be a pin or an electrical node of the electrical circuitry. A voltage may be generated on the port. A current may flow out of the port or into the port. Exemplary, in case of I2C only one data transmission line may be used connected to an input/output port, e.g. a port that may switch its communication direction. However, such ports may be useful in many other embodiments.

According to an embodiment, a shift register based communication may be used for the communication between the first communication unit and the second communication unit, e.g. an SPI (Serial Peripheral Interface) communication or an SSI (Synchronous Serial Interface) communication, see details mentioned below. A shift register based transfer may be implemented using simple shift registers. Furthermore, shift register based communication may be a robust communication.

According to an embodiment, data transmission may be performed without transmitting an address of the first communication unit and/or without transmitting an address of the second communication unit, e.g. an SPI communication or an SSI communication, see details mentioned below. Thus, communication overhead for transmission of addresses may be avoided.

There may be no addresses of the first communication unit and of the second communication unit at all. This may simplify the communication units.

An output of a shift register within the first communication unit may be electrical connected to an input of the shift register within the second communication unit. An output of the shift register within the second communication unit may be electrical connected to an input of the shift register of the first communication unit. Thus, sending and receiving is performed at the same time, e.g. synchronous to each other and/or synchronous to the clock signal.

Two data transmission lines or conductive paths on a PCB (printed circuit board) or on another appropriate carrier may be used.

SPI (Serial Peripheral Interface) is an interface proposed by Motorola in AN991 (Application node). Later NXP proposed further developments in AN991/D. Variants of the SPI and/or further developments thereof may be used. Single SPI (only one chain of shift registers), Dual SPI (two chains of serial shift registers), Quad SPI (four chains of serial shift registers), etc. may be used.

SPI may allow fast (high speed) transmission due to push-pull drivers. Thus, tri-state push-pull drivers may be used. No pull up resistors may be necessary.

SSI (Synchronous Serial Interface) is an interface using differential signals or another interface using differential signals may be used. Thus, the communication may be EMC (electromagnetic Compatibility) robust.

According to an embodiment, the first communication unit and the second communication unit may be part of a serial communication bus. The first communication unit may have a first address and the second communication unit may have a second address. The first communication unit may use the second address to address the second communication unit and/or vice versa. Address data that is transmitted via the data line may be used for this purpose. There may be only one data line and only one clock line. The bus may be an I2C (IIC, Inter-Integrated Circuit) bus or an I3C bus, or another appropriate bus.

Open drain (MOSFET, metal (or highly doped semiconductor) oxide semiconductor field effect transistor) or open-collector (BJT, bipolar junction transistor) may be used. Thus, pull-up resistors may be used.

I2C is a bus proposed in U.S. Pat. No. 4,689,740 (Philips Corp., today part of NXP). This, document is incorporated by reference herewith for all legal purposes. I3C (also known as Sensewire) is a bus proposed by MIPI (Music Industries Piracy Investigations Alliance). Alternatively, an SMBus (System management Bus) may be used.

According to an embodiment, the device may comprise at least one of:
A first direct memory access (DMA) unit that transfers data from the sensor or from a first memory unit to the first communication unit, or
A second direct memory access (DMA) unit that transfers data from the second communication unit to a second memory unit or to another unit used to transfer the digital data received via the second communication unit.

Usage of DMA may result in shorter data transfer rates, e.g. since only one address has to be used to transfer several data word consecutively.

According to a further embodiment, in the input device or the optical input device comprising DMA, at least one of the first memory unit or a part thereof and the second memory unit or a part thereof may be organized as a circular buffer (ring buffer). A FIFO (first in first out) may be used as well. The buffer may be with overwriting or with preventing overwriting before reading by memory management, e.g. data pointers (address for read and write) may be compared to each other. A circular buffer may be implemented using four pointers, or two pointers and two integers:
Buffer start in memory, and/or
Buffer end in memory, or buffer capacity, and/or
Start of valid data (index or pointer), and/or
End of valid data (index or pointer), or amount of data currently in the buffer (integer).

According to an embodiment, the first communication unit may be comprised in a first electrical unit. The second communication unit may be comprised in a second electrical unit. A first control port of the first electrical unit may be adapted to receive a signal that indicates whether the first communication unit is the controlling unit and/or whether the second communication unit is the controlling unit. A second control port of the second electrical unit may be adapted to send a signal that indicates whether the first communication unit is the controlling unit and/or whether the second communication unit is the controlling unit. The first control port and the second control port may be electrically connected to each other.

According to an embodiment, the first control port and the second control port may be different from an enable port or from enable ports of the communication unit(s), see variant V2 mentioned below. Alternatively, the first control port and the second control port may be ports of the communication unit(s), see variant V4 mentioned below. SS (SPI select) signal, e.g. low active.

Alternatively, it may be communicated what the secondary unit (controlled unit or target unit) is. Thus, the controlling unit may be indirectly be known if there are only two units. Again, a port may be a pin or a node in the circuitry.

According to an embodiment, the first communication unit may be adapted to send digital control data to the second communication unit. The digital control data sent by the first communication unit or by the 2^{nd} control unit may indicate that the second communication unit has to operate as the controlling unit for further data transfer. Alternatively or additionally, the first communication unit may be adapted to receive digital control data from the second communication unit. The digital control data received by the first communication unit may indicate that the first communication unit has to operate as the controlling unit for further data transfer. It is of course also possible to use the control data to indicate what the secondary unit is. The master unit may be known indirectly if only two units are used.

According to an embodiment, the control data may be transmitted via the same port that is used for transmission of the digital data, e.g. sensor raw data or processed data based on sensor raw data. Thus, no separate port may be necessary in order to transmit control data. However, in other embodiments a separate port may be contemplated.

According to an embodiment, the sensor may be a radiation sensor, e.g. for sensing electromagnetic radiation. The device may be adapted such that the digital data is data generated by the radiation sensor or data generated by an analog digital converter that converts analog sensor output data to digital data. Preferably, the optical input device may be adapted such that for each picture element of the radiation sensor corresponding data is transmitted.

The device may be an optical input device, a camera or another imaging device, e.g. a medical imaging device, CT (Computer Tomography), MRT (Magnetic Resonance Tomography), ultra sound imaging, etc.

Alternatively, e.g. in embodiments in which the sensor is a radiation sensor, the device may comprise a first processing unit that is adapted to process data generated by the radiation sensor and to generate movement data indicating movement of the optical input device. The movement data may be preferably movement data that relates to a first direction of movement and/or movement data that relates to a second direction of movement which is perpendicular to the first direction, e.g. an x-direction (delta x data) and an y-direction (delta y data).

According to an embodiment, the device may comprise a first electrical unit that comprises at least one first integrated chip and a second electrical unit that comprises at least one second integrated chip, especially a semiconductor chip. Usage of several chips may result in better specialization of producers. Furthermore, degrees of freedom of design may be higher if at least two chips are used.

According to an embodiment, the device may be an optical input device, e.g. a computer mouse device. The optical input device may comprise at least one of, at least several or all of the following elements:
At least one button, e.g. left mouse button and right mouse button and optional middle button, and/or
At least one rotatable wheel, and/or
An ergonomic case adapted to the hand of a user.

According to an embodiment, the sensor may have less than 10000 pixels (picture elements), less than 2500 pixels or less than 1025 pixels.

According to a further embodiment, the case may be shorter than 15 cm (centimeter) and smaller than 10 cm in width. The case may be appropriate for a hand of adult or may be appropriate for the hand of a child.

According to a further embodiment, the device, especially the optical input device (mouse) may comprise at least one further optical element, e.g. a lens, e.g. part of LED housing or a separate optical lens or another beam shaping element.

According to an embodiment, the device may comprise a processing unit that is adapted to realize a third communication unit, preferably a communication unit that transmits data via a wire, e.g. according to the USB (Universal Serial Bus) standard. USB 1.0, 1.1, 2.0, 3.0, 3.1, 3.2, USB4 or higher may be used. Alternatively, other wire based protocols may be used.

According to an embodiment, the optical input device may comprise a processing unit that is adapted to realize a third communication unit, preferably a communication unit that transmits data wireless, e.g. according to Bluetooth proposed by the Bluetooth Special Interest Group. Bluetooth 1.1., 1.2, 2.0+EDR (Enhanced Data Rate), 2.1+EDR, 3.0+HS, 3.0+EDR, 4.0, 4.1, 4.2 Smart, 5, 5.1, 5.2 or higher may be used. Alternatively, other wireless protocols may be used, e.g. Zigbee or Z-wave.

According to a further aspect, a method for changing of the controlling unit for data transmission is disclosed, especially a method that uses a device according to one of the embodiments mentioned above:
Wherein a first communication unit is defined as the controlling unit during a first operation mode of the communication units and a second communication unit is defined as the controlled unit during the first operation mode of the communication units,
Wherein the first communication unit and the second communication unit are adapted for synchronous communication according to a clock signal generated by the first communication unit or the second communication unit depending on which one is the controlling unit,
Wherein first digital data is transmitted from the first communication unit to the second communication unit under control of the first communication unit,
Wherein the digital data may comprise data generated by the sensor or processed data derived from data generated by the sensor,
Wherein after the transmission of the first digital data a control code is transmitted from the first communication unit to the second communication unit or from the second communication unit to the first communication unit via the same transmission channel as the digital data, wherein the control code specifies that the second communication unit has to be the controlling unit for further data transfer, and
Wherein after transmission of the control code second digital data is transmitted from the first communication unit to the second communication unit under control of the second communication unit.

The controlling unit may generate the clock signal for the synchronous data transmission. Thus, changing of the controlling functionality (master) between the two communication units may involve a change of the clock generating unit.

It is alternatively possible to use control data that defines the controlled unit. Thus, it may be implicitly be clear which unit has to be used as the master unit, e.g. if only two communication units are involved.

According to a further embodiment of the method, SPI or I2C or other protocols mentioned above may be used for the data transfer of the data.

According to a further embodiment of the method, the method may be used in wide variety of applications, e.g. involving optical sensors or not. The method may be used in an optical input device, e.g. in a computer mouse device. Industrial applications may be contemplated as well, e.g. within a production line, e.g. from semiconductor production, car production, plane production, chemical material production, medicament production, etc.

According to a further embodiment of the method, the same or similar control code may be used to change the controlling functionality again, e.g. from the second communication unit to first communication unit.

The foregoing has outlined rather broadly the features and technical advantages of embodiments of the present disclosure. Additional features and advantages of embodiments of the present disclosure will be described hereinafter. These features may be the subject-matter of dependent claims. It should be appreciated by those skilled in the art that the conception and specific embodiments disclosed may be readily utilized as a basis for modifying or designing other structures or processes for realizing concepts which have the same or similar purposes as the concepts specifically discussed herein. It should also be recognized by those skilled in the art that equivalent constructions do not depart from the spirit and scope of the disclosure, such as defined in the appended claims.

For a more complete understanding of the presently disclosed concepts and the advantages thereof, reference is now made to the following description in conjunction with the accompanying drawings. The drawings are not drawn to scale. In the drawings the following is illustrated in:

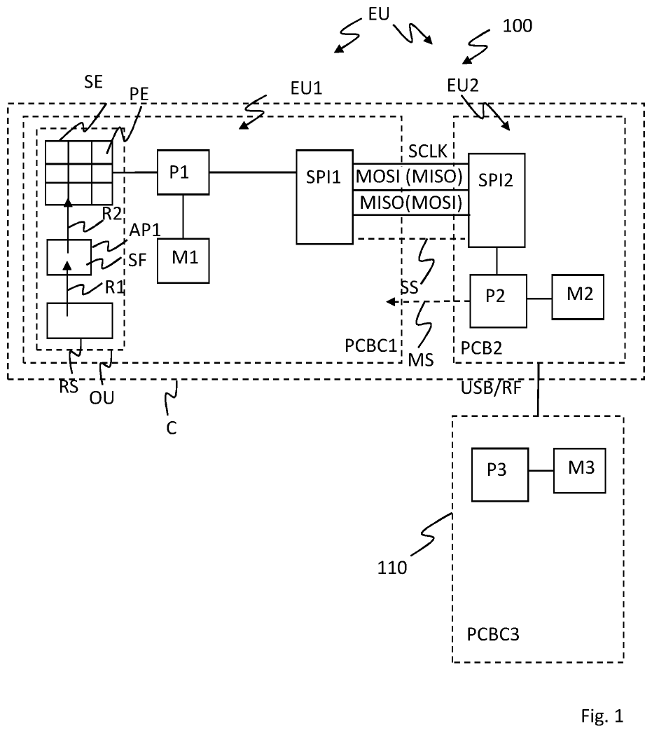

FIG. 1 an optical input device comprising an SPI interface with master functionality on the sensor side,

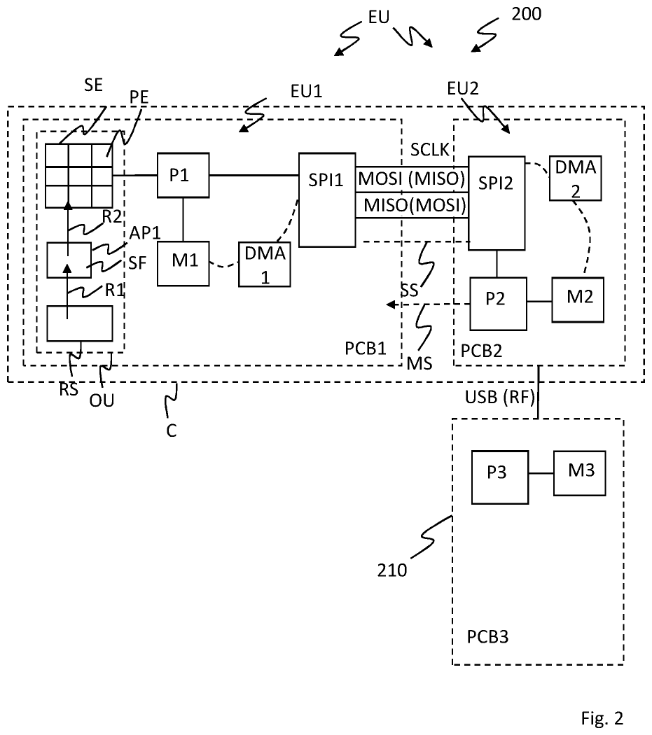

FIG. 2 an optical input device comprising an SPI interface combined with a DMA unit on the sensor side,

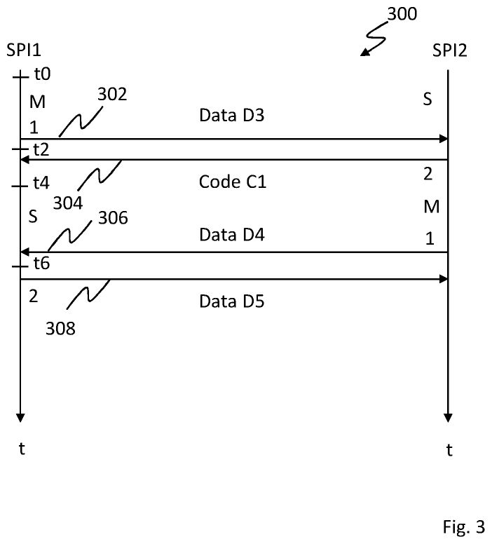

FIG. 3 a method for changing the master functionality between two SPI units using a control instruction that is transmitted via the SPI, and

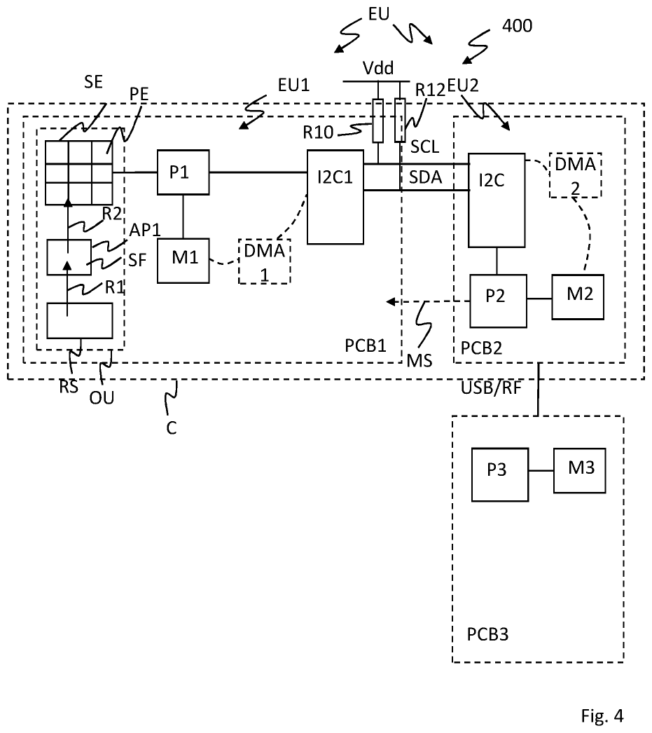

FIG. 4 an optical input device comprising an I2C interface with master functionality on the sensor side, and

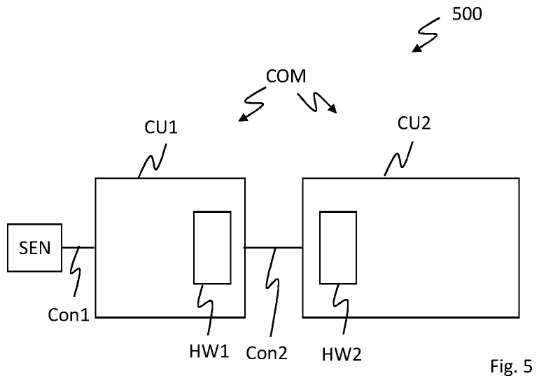

FIG. 5 a device of a more general embodiment.

FIG. 1 illustrates an optical input device 100 comprising an SPI (Serial Periphery Interface) interface with master functionality on the sensor side during a first operation mode I of device 100. Optical input device 100 may be a computer mouse device comprising a case C, preferably a case C that is ergonomically adapted to the hand of a user (not shown). Optical input device 100 may comprise:
An optical unit OU, and
An electrical unit EU.

Optical unit OU may comprise:
A radiation source RS (light source) e.g. LED (Light Emitting Device),
An aperture AP1, e.g. a hole, e.g. an elongated hole or at least a transparent area that is transparent for the radiation of the radiation source, and
A radiation sensor SE, e.g. a CCD or a CMOS sensor, e.g. a sensor that is sensitive for the radiation that is radiated by the radiation source RS.

Radiation source RS and radiation sensor SE may also be parts of electrical EU as they combine electrical and optical functions. A radiation R1 may be radiated by radiation source RS through aperture AP1 onto a surface SF. Surface SF may reflect a part of the incoming radiation back through aperture AP1 or through another aperture onto radiation sensor SE. Thus, it may be possible to detect movement of optical input device onto surface SF.

Radiation sensor SE may comprise a plurality of pixels (picture element) PE, e.g. more than 100 pixels PE or more than 200 pixels PE. Upper limits for the number of pixel elements are mentioned in the first part of this document. Alternatively or additionally, it may be possible to arrange a radiation sensor near rotating parts of the mouse, e.g. near a mouse wheel in order to detect movement of this part. Data generated by the radiation sensor near a rotating part may be transferred and/or processed as described below for data of radiation sensor SE.

Electrical unit EU may comprise:
An electrical (electronic) unit EU1, and
An electrical (electronic) unit EU2.

Electrical unit EU1 may comprise:
Radiation sensor SE,
Radiation source RS, e.g. an LED, preferably a driver circuit for the radiation source, e.g. an LED driver circuit,
A first processor P1, e.g. a microprocessor or a microcontroller,
A first memory M1, e.g. RAM (Random Access Memory) and/or xROM (Read Only Memory), where x may stand for P (programmable), EP (Erasable P), EEP (Electrically EP), Flash-EEP, or other kinds of memory,
A first SPI unit SPI1.

Processor P1 may be connected to radiation sensor SE, memory M1 and SPI unit SPI1, e.g. by an address bus and/or a data bus. Processor P1 may execute instructions stored within memory M1 or within an internal memory of processor P1. According to a first alternative, processor P1, e.g. a DSP (digital signal processor) performs image processing of sensor data in order to detect movement data D2b, comprising e.g. delta x data and delta y data. Movement data delta x may indicate the movement that occurred during movement of the mouse along an x direction, e.g. away from a user. Movement data delta y may indicate the movement that occurred during movement of the mouse along an x direction, e.g. to the right or to the left relative to the user. Processed data D2b may then be transferred by processor P1 to electrical unit EU2 using the SPI unit SPI. Thus, the amount of data is reduced tremendously. Movement detection is known in the art, e.g. using cross-correlation calculations, surface quality values (SQUAL), block-matching (e.g. according to a matching function, mean square error (MSE), mean absolute difference (MAD), etc.)

According to a second alternative, raw data D2 of radiation sensor SE may be transferred by processor P1 to electrical unit EU2 using the SPI unit SPI1. There may be raw data for each pixel of radiation sensor SE. Raw data may be digital data, e.g. generated from analog data using an ADC (Analog Digital Converter). Furthermore, raw data may be pre-processed, e.g. using a filter function, e.g. a two dimensional filter functions, e.g. a function known from image processing. Examples may be smoothing, edge detection, etc. This amount of data may be transferred to electrical unit EU2 for processing using high speed SPI units, e.g. units that may transfer more than 1 Mbit (Megabit) per second or more than 10 Mbit per second. Electrical unit EU2 may comprise a processor P2 that may have more calculating power compared to processor P1. However, there may be other technical advantages of the second alternative, e.g. with regard to system integration, independency of the manufacturer of the radiation sensor, etc.

Electrical unit EU2 may comprise:
A second processor P2, e.g. a microprocessor or a microcontroller,
A second memory M2, e.g. RAM (Random Access Memory) and/or xROM (Read Only Memory), where x may stand for P (programmable), EP (Erasable P), EEP (Electrically EP), Flash-EEP, or other kinds of memory, and
A second SPI unit SPI2.

Processor P2 may be connected to memory M2 and SPI unit SPI2, e.g. by an address bus and/or a data bus. Processor P2 may execute instructions stored within memory M2 or within an internal memory of processor P2. According to the first alternative, processor P2 may transfer movement data D2b to a computer 110, see description below.

According to the second alternative, processor P2 may process raw data D2 in order to generate movement data and/or other data using e.g. correlation calculation or other appropriate algorithms. Also according to the second alternative, processor P2 may transfer movement data and/or other processed data to computer 110. This is described in more detail below.

A printed circuit board PCB1 may comprise or carry the following elements:
Optical unit OU, and
Electrical unit EU1.

A printed circuit board PCB2 may comprise:
Electrical unit EU2, e.g. comprising the firm ware used to realize the mouse function.

Printed circuit board PCB1, PCB2 may comprise at least one layer of electrical lines or electrically conducting conductors. Multilayer boards may be used as well. FR-4 material or other electrically isolating material may be used, e.g. FR-4 glass epoxy material. Both printed circuit boards PCB1 and PCB2 may be arranged within case C of optical input device 100. Alternatively, more than two printed circuit boards or only one printed circuit board may be used within optical input device 100.

Processor P1, memory M1 and SPI unit SPI1 may be arranged on one semiconductor chip, e.g. within a microcontroller chip. Silicon may be used as the main material of the die or chip. Furthermore, also radiation sensor SE may be integrated into the same chip as Processor P1, memory M1 and SPI unit SPI1. However, radiation sensor SE may be produced on a separate chip apart from Processor P1, memory M1 and SPI unit SPI1. Alternatively, separate chips may be used for processor P1, memory M1 and SPI unit SPI1.

Similarly, processor P2, memory M2 and SPI unit SPI2 may be arranged on one further semiconductor chip, e.g. within a microcontroller chip. Alternatively, separate chips may be used for processor P2, memory M2 and SPI unit SPI2.

SPI unit SPI1 may operate as an SPI interface as mentioned in the first part of this document. There may the following ports, pins or lines on or connected to SPI unit SPI1:
A clock line SCLK (Serial Clock, other names may be used as well),
A data line MOSI (Master Out Secondary In, other names may be used as well), e.g. during a first operation mode I of device 100 in which unit SPI1 has master functionality,
A data line MISO (Master In Secondary Out, other names may be used as well), e.g. during the first operation mode I of device 100 in which unit SPI1 has master functionality, and
An optional line SS (SPI select) which may be optional if only two SPI units are used.

Data line MOSI may be used as data line MISO during a second operation mode II in which unit SPI1 has functionalities of a secondary unit. Data line MISO may be used as data line MOSI during the second operation mode II in which unit SPI1 has functionalities of a secondary unit.

SPI unit SPI2 may operate as an SPI interface as mentioned in the first part of this document. There may the following ports, pins or lines on or connected to SPI unit SPI2:
Clock line SCLK (Serial Clock, other names may be used as well),
Data line MOSI (Master Out Secondary In, other names may be used as well), e.g. during the first operation mode I of device 100 in which unit SPI2 has functionality of a secondary unit,
Data line MISO (Master In Secondary Out, other names may be used as well), during the first operation mode I of device 100, and
Optional line SS (SPI select) which may be optional if only two SPI units are used.

Data line MOSI may be used as data line MISO during a second operation mode II in which unit SPI1 has functionalities of a secondary unit. Data line MISO may be used as data line MOSI during a second operation mode II in which unit SPI1 has functionalities of a secondary unit.

The clock signal on clock line SCLK is or may be always generated by the master unit. Thus, exemplary, if the master unit changes between SPI unit SPI1 and SPI unit SPI2, unit SPI1 generates the clock signal before the change and unit SPI2 generates the clock signal after the change.

No pull-up resistors may be necessary on lines SCLK, MOSI and MISO. Thus, tri-state outputs and/or inputs may be used, e.g. using push-pull transistor drivers.

According to a first variant V1, SPI unit SPI1 may be a master unit and SPI unit SPI2 may be the secondary unit without a possibility of changing the master function.

According to a second variant V2, changing of the master functionality between unit SPI1 and unit SPI2 may be possible using a separate pin that is not part of the SPI interface, e.g. master select pin MS. This pin may be a general purpose input/output pin (GPO) of processor P1, e.g. of a microprocessor or microcontroller that may comprise more periphery units compared to a microprocessor. A GPO a pin may be a pin that may be used by the programmer to input data or to output data depending on his/her need, e.g. independent of using an SPI function or not. This may be named as an out of band communication of the change of the master functionality.

According to a third variant V3, changing of the master functionality between unit SPI1 and unit SPI2 may be possible using commands or control instructions that are transferred via the SPI, e.g. via lines MOSI and/or MISO. This is described below in more detail relating to FIG. 3. This may be named as an in-band communication of the change of the master functionality.

According to a fourth variant V4, changing of the master functionality between unit SPI1 and unit SPI2 may be possible using a signal on a dedicated pin of the SPI interface, e.g. a secondary select (SS) signal or a master select signal on the SPI interface.

According to a fifth variant V5, change of the master functionality may be performed after lapse of a defined period of time, e.g. after 1 ms (millisecond).

According to a sixth variant V6, change of the master functionality may be performed after a pregiven number of transmissions, e.g. after 10 transmission of data, after more than 10 transmission of data or after 100 transmissions of data.

Further variants are possible as well.

Further, FIG. 1 illustrates also a computer 110 that is operated by a user using optical input device 100 (mouse). Computer 110 may be a PC (personal computer, windows operating system), a MAC (may be a trademark) using an IOS (may be a trade mark) operating system or a computer using other operating systems, e.g. LINUX or derivates thereof.

An USB line USB may be used to connect device 100 to computer 110. If USB is used, optical input device 100 may not include a separate power source since electrical power may be provided via the USB cable.

Alternatively a wireless connection may be used, e.g. a RF (radio frequency). If RF is used, optical input device 100 may comprise a separate electrical power source, e.g. a disposable battery or a rechargeable battery as well as an optional electrical power unit that powers optical input device 100.

Computer 110 may comprise at least one printed circuit board PCB3. Printed circuit board PCB3 may comprise or carry at least one processor P3, memory M3, etc. Further units may be comprised in computer 110, e.g. an electrical power unit, a display unit, a keyboard and/or a touch screen, etc. Processor P3 and memory M3 or other parts of computer 110 may be used to realize a USB host if a USB line is used between mouse device 100 and computer 110. Mouse device 110 may comprise a USB device implemented using e.g. processor P2 and memory M2. Device Class HID (Human Device Interface) of extended USB Standard may be used to implement the USB connection.

Alternatively, if a wireless connection is used between mouse device 100 and computer 110, computer 110 may comprise a unit that is able to communicate wirelessly with mouse device 100, e.g. via Bluetooth.

There may be the following advantages and/or technical effects if SPI unit SPI1 operates as a master unit and SPI unit SP2 operates as a secondary (slave) unit:
Sensor data D2 or D2b may be transferred immediately after it is generated due to a movement of device 100 by the user,
Short latency times may be reached for transfer of sensor data D2 or D2b, e.g. compared to polling method in which the master function is on the side of electrical unit EU2,
All movement data may be transmitted compared to scenarios in which only accumulated movement data is transmitted,
Movement of a cursor on a display may correspond more exactly to the movement of the hand of the user, and/or
All raw data may be transmitted.

There may be the following advantages and/or technical effects if switching of master unit is possible:
During start and/or reset phase master functionality may be on the side of electrical unit EU2 allowing setting parameters of electrical unit EU1 in a simple manner, e.g. resolution, gaming mode (high performance, low power, corded), lift detection settings, sensitivity, etc.
A register structure, e.g. a register interface that is realized in memory M1, of registers in electrical unit EU1 from electrical unit EU2 may be realized in a simpler way if electrical unit EU2 is the master unit, e.g. unit SPI2,
Burst mode for writing registers, e.g. in memory of electrical unit EU1 using electrical unit EU2 may be easier, and/or
Transmission of sensor data D2, D2b may be more efficient if electrical unit EU1 is the master unit as mentioned above.

One possible example for implementing an SPI interface is using a PIC P16F877A processor produced by Microchip Technology Inc. Alternatively, other processors, e.g. Atmel ATmega48 (88, 168) of Microchip Technology Inc. or of other companies may be used as well thereby slightly adapting the code to the respective processor. Alternatively, separate or single communication units or chips (dies) may be used for SPI unit(s) that are external to a processor, e.g. microprocessor, microcontroller, etc.

A single communication unit may be used only on one side or on both sides of the communication connection.

FIG. 2 illustrates an optical input device 200 comprising an SPI interface combined with a DMA unit DMA1 on the sensor side. Optical input device 200 may comprise the same components as optical input device 100, e.g. radiation sensor SE, processor P1. Thus, the same description applies. However, the difference between optical input device 200 and optical input device 100 is that direct memory access (DMA) is used in optical input device 200 in at least one of the electrical units EU1 and/or EU2 as is explained in the following in more detail.

Electrical unit EU1 may comprise:
A direct memory access unit DMA1 that may transmit data, e.g. data D2, D2b from memory M1 to SPI unit SPI1 without involving a CPU (central processing unit), e.g. without involving processor P1.

Electrical unit EU2 may comprise:
A direct memory access unit DMA2 that may transmit data e.g. data D2, D2b from SPI unit SPI2 to memory M2 without involving a CPU (central processing unit), e.g. without involving processor P2.

A part of first memory unit M1 or of other memory and/or a part of the second memory unit M2 or of other memory may be organized as a circular buffer (ring buffer) in order to ease DMA data transfers. FIFO (first in first out) principle may be used and/or with overwriting or with preventing overwriting before reading of cells by memory management, e.g. compare data pointers (Address for read and write). A circular buffer can be implemented using four pointers, or two pointers and two integers:
Buffer start in memory,
Buffer end in memory, or buffer capacity,
Start of valid data (index or pointer), and
End of valid data (index or pointer), or amount of data currently in the buffer (integer).

DMA may accelerate the data transfer considerably, e.g. shorten the time necessary to transfer the same amount of data. DMA may be especially effective for the transmission of sensor raw data D2, especially after occurring of movement or according to a fixed or variable time frame.

Optical input device 200 may be connected by wire or wirelessly to a computer 210. Computer 210 may be the same as or a similar one as computer 110. Thus, the description of computer 110 applies also to computer 210. Again an USB connection may be used or a wireless connection.

FIG. 3 illustrates a method 300 for changing the master functionality between two SPI units using a control instruction C1 that is transmitted via the SPI. This may correspond to variant V3 mentioned above.

Method 300 is illustrated using two time lines t. One time line t is on the side of unit SPI1 and the other time line is on the side of unit SPI2.

At time to, unit SPI1 is the master M unit and unit SPI2 is the secondary S unit. Thus, data transmission is controlled by unit SPI1, e.g. the clock on line SCLK is generated within unit SPI1. Unit SPI2 receives the clock signal and does not generate a clock signal on line SCLK.

At time t2 data D3, e.g. sensor data D2 or data D2b may be transmitted from unit SPI1 to unit SPI2 under control of unit SPI1, see transmission 302. At the same time, unit SPI2 may transmit user data or control data C1 to unit SPI1, see transmission 304. Control data C1 may comprise a code word that has set a specific bit in order to indicated that control data is transmitted but no user data. Other possibilities to define a control data (instruction) may be used as well. Control data C1 may indicate that the master functionality has to be changed, e.g. that unit SPI2 wants to become the master of the SPI transfer. It may of course be possible to transfer control data C1 from SPI unit SPI1 to SPI unit SP2 in order to indicate that unit SPI1 wants a change of the master M unit, e.g. that unit SPI2 should be the master unit for future data transfer.

At time t4, unit SPI1 processes control data C1 and detects that a change of the master functionality is requested. Accordingly, appropriate steps are performed on the side of unit SPI1, e.g. by processor P1 in order to establish secondary S mode in unit SPI1 for data transfer. Thus, at least one appropriate flag(s) may be set in at least one register(s) that control the SPI transfer of unit SPI1. Finally, unit SPI1 enters into secondary S mode, e.g. it does not generate clock signals for SPI transmission and has a passive role.

Moreover, also on the side of unit SPI2 appropriate steps are performed to establish the master M mode for data transfer, e.g. by processor P2. Thus, at least one appropriate flag(s) may be set in at least one register(s) that control the SPI transfer of unit SPI2. Finally, unit SPI2 enters into master M mode, e.g. it will now generate clock signals SCLK for SPI transmission and will have an active role for data transfer.

Exemplary, at time t6, unit SPI2 initiates a further data transfer. Data D4 may be transmitted from unit SPI2 to unit SPI1 using a clock signal on line SCLK generated by unit SPI2, see transmission 306.

At the same time t6, data D5 may be transferred from unit SPI1 to unit SPI2, using the clock signal on line SCLK generated by unit SPI2, see transmission 308.

Further changes of the master functionality may occur later. It is of course possible to start with the master functionality on the side of unit SPI2.

The same method 300 or a similar method may be used if an I2C bus is used. An embodiment for I2C is described below in more detail. The advantage of method 300 is that complicated arbitration (as proposed by I2C for arbitration between several master units) may not be necessary on the I2C bus if control data C1 is used to signal changes of master M functionality between a master unit and a secondary unit. This may simplify implementation of an I2C bus considerably.

FIG. 4 illustrates an optical input device 400 comprising an I2C interface with master functionality on the sensor side during a first operation mode I. Optical input device 400 may comprise the same components as optical input device 100, e.g.

radiation sensor SE, processor P1, etc. Thus, the same description applies. However, the differences between optical input device 400 and optical input device 100 are:
A I2C unit I2C1 is used instead of SPI unit SPI1 within electrical unit EU1,
A I2C unit I2C2 is used instead of SPI unit SPI2 within electrical unit EU2,
Only two lines are used between unit I2C1 and unit I2C2 for I2C transmission,
A clock line SCL (Serial clock, other names are possible as well) is used for transmission of the clock signal for data transfer. Again the clock signal is generated by the master M,
A Data transmission line SDA (Serial Data, other names are possible as well) may be used, especially only one data transmission line.

There may be optional pull-up resistors R10, R12 connected to positive operation potential Vdd and to clock line SCL or to data line SDA in order to allow usage of open collector or open drain lines.

According to a first variant V1, I2C unit I2C1 may be a master unit and I2C unit I2C2 may be the secondary unit without a possibility of changing the master function, e.g. there is only one operation mode I of device 400.

According to the following variants V2 to V6 there may be also a second operation mode II of device 400 in which unit I2C2 has the master function or master functionality.

According to a second variant V2, changing of the master functionality between unit I2C1 and unit I2C2 may be possible using a separate pin that is not part of the I2C interface, e.g. master select pin MS. This pin may be a general purpose input/output pin (GPO) of processor P1, e.g. of a microprocessor or microcontroller that may comprise more periphery units compared to a microprocessor. A GPO a pin may be a pin that may be used by the programmer to input data or to output data depending on his/her need, e.g. independent of using an I2C function or not. This may be named as an out of band communication of the change of the master functionality.

According to a third variant V3, changing of the master functionality between unit I2C1 and unit I2C2 may be possible using commands or control instructions that are transferred via the I2C, e.g. via line SDA (Serial Data). This is described above in more detail relating to FIG. 3. This may be named as an in-band communication of the change of the master functionality.

According to a fourth variant V4, changing of the master functionality between unit I2C1 and unit I2C2 may be possible using a signal (out of band) on a dedicated pin of the I2C interface, e.g. a secondary select (SS) signal or a master select signal on the I2C interface.

According to a fifth variant V5, change of the master functionality may be performed in device 400 after lapse of a defined period of time, e.g. after 1 ms (millisecond).

According to a sixth variant V6, change of the master functionality may be performed in device 400 after a pregiven number of transmissions, e.g. after 10 transmission of data, after more than 10 transmission of data or after 100 transmissions of data.

Further variants are possible as well.

The function of device 400 may be similar to the function of device 100 as described above. Thus, optical input device 400 may be connected by wire or wirelessly to a computer 410. Computer 410 may be the same as or a similar one as computer 110. Thus, the description of computer 110 applies also to computer 410. Again an USB connection may be used or a wireless connection may be used to connect optical input device 400 and computer 410.

According to a first alternative of optical input device 400, no DMA may be used, i.e. neither within electrical unit EU1 nor within electrical unit EU2 for data transmitted via I2C.

According to a second alternative of optical input device 400, DMA may be used in at least one of electrical unit EU1 or within electrical unit EU2 for data transmitted via I2C. Thus, the description of DMA mentioned above, see description of FIG. 2 does apply also to optical input device 400, e.g. usage of a circular buffer.

One possible example for implementing an I2C interface is using a PIC P16F877A processor produced by Microchip Technology Inc. Alternatively, other processors, e.g. Atmel ATmega48 (88, 168) of Microchip Technology Inc., see TWI (Two wire serial interface) that is compatible to I2C, or of other companies may be used as well thereby slightly adapting the code to the respective processor. Alternatively, separate or single communication units or chips (dies) may be used to realize the I2C bus system, e.g. on one side or on both sides of the communication. These communication units may be are external to a processor, e.g. microprocessor, microcontroller, etc.

FIG. 5 illustrates a device 500 of a more general embodiment. Device 500 comprises:
A sensor SEN, and
A communication system COM.

Sensor SEN may be any sensor, e.g. humidity, optical, capacitive, etc. Furthermore, a plurality of sensors of the same sensor type or of a variety of sensor types may be connected to device 500.

Communication system COM may comprise:
A first communication unit CU1, and
A second communication unit CU2.

First communication unit CU1 may comprise a hard ware HW1, e.g. an SPI unit or an I2C unit as explained above in more detail. Similarly, second communication unit CU2 may comprise hard ware HW2, e.g. an SPI unit or an I2C unit as explained above in more detail.

There may be the following connections:
A connection Con1 between sensor(s) SEN and communication unit CU1, and
A connection Con2 between first communication unit CU1 and second communication unit CU2.

During a first operation mode I of device 500, first communication unit CU1 may have the master functionality, e.g. in order to transmit data generated by sensor(s) SEN to a more central processing unit or to an output unit. During the first operation mode I of device 500, second communication unit CU2 may have the functionality of a secondary unit.

During a second operation mode II of device 500, second communication unit CU2 may have the master functionality, e.g. in order to perform setting of parameters of sensor(s) SEN using a more central processing unit. During the second operation mode II of device 500, first communication unit CU1 may have the functionality of a secondary unit.

Switching of the master functionality in device 500 may be possible according to all six variants V1 to V6 mentioned above. Adaption of these variants V1 to V6 to other communication protocols, buses or interfaces may be possible as well.

In other words, a device 100, 200, 400, 500 is disclosed, especially input device 100 to 400, comprising a sensor SEN,
wherein the device 500 comprises a first communication unit CU1, SPI1, I2C1 and a second communication unit CU2, SPI2, I2C2 that are adapted for synchronous communication according to a clock signal SCLK, SCL generated by the first communication unit CU1, SPI1, I2C1 or by the second communication unit CU2, SPI2, I2C2,
wherein the first communication unit CU1, SPI1, I2C1 is adapted to send digital data D2 or D2b to the second communication unit CU2, SPI2, I2C2,
wherein the digital data D2 or D2b comprises data D2 generated by the sensor SEN or processed data D2b derived from data D2 generated by the sensor SEN,
wherein the first communication unit CU1, SPI1, I2C1 is adapted to be used as a controlling unit during the transmission of the digital data D2 or D2b during a first operation mode of the communication units CU1, CU2,
wherein the second communication unit CU2, SPI2, I2C2 is adapted to be used as a controlled unit during the transmission of the digital data D2 or D2b during the first operation mode of the communication units CU1, CU2, and
wherein the controlling unit generates the clock signal SCLK, SCL for the controlled unit.

Furthermore, a method 300 is disclosed for changing of the controlling unit for data transmission, especially using a device 100, 200, 400, 500 according to one of the embodiments mentioned above,
wherein a first communication unit CU1, SPI1, I2C1 is defined as the controlling unit during a first operation mode of the communication units CU1, CU2 and a second communication unit CU2, SPI2, I2C2 is defined as the controlled unit during the first operation mode of the communication units CU1, CU2,
wherein the first communication unit CU1, SPI1, I2C1 and the second communication unit CU2, SPI2, I2C are adapted for synchronous communication according to a clock signal SCLK, SCL generated by the first communication unit CU1, SPI1, I2C1 or the second communication unit CU2, SPI2, I2C2 depending on which one is the controlling unit,
wherein first digital data D3 is transmitted from the first communication unit CU1, SPI1, I2C1 to the second communication unit CU2, SPI2, I2C2 under control of the first communication unit CU1, SPI1, I2C1,
wherein preferably the digital data D2 or D2b, D3 comprises data D2, D3 generated by the sensor SEN, SE or processed data D2b derived from data D2, D3 generated by the sensor SEN, SE,
wherein after the transmission of the first digital data D3 a control code C1 is transmitted between the first communication unit CU1, SPI1, I2C1 and the second communication unit CU2, SPI2, I2C2, e.g. from the first communication unit CU1, SPI1, I2C1 to the second communication unit CU2, SPI2, I2C2 or vice versa via the same transmission channel as the digital data D3, wherein the control code C1 specifies that the second communication unit SPI2, I2C2 has to be the controlling unit for further data transfer, and
wherein after transmission of the control code C1 second digital data D4 is transmitted from the second communication unit SPI2, I2C2 to the first communication unit SPI1, I2C1 under control of the second communication unit SPI2, I2C2.

Although embodiments of the present disclosure and their advantages have been described in detail, it should be understood that various changes, substitutions and alterations can be made therein without departing from the spirit and scope of the disclosure as defined by the appended claims. For example, it will be readily understood by those skilled in the art that many of the features, functions, processes and methods described herein may be varied while remaining within the scope of the present disclosure. Moreover, the scope of the present application is not intended to be limited to the particular embodiments of the system, process, manufacture, method or steps described in the present disclosure. As one of ordinary skill in the art will readily appreciate from the disclosure of the present disclosure, systems, processes, manufacture, methods or steps presently existing or to be developed later that perform substantially the same function or achieve substantially the same result as the corresponding embodiments described herein may be utilized according to the present disclosure. Accordingly, the appended claims are intended to include within their scope such systems, processes, methods or steps. The embodiments mentioned in the first part of the description may be combined with each other. The embodiments of the description of figures may also be combined with each other. Further, it is possible to combine embodiments mentioned in the first part of the description with examples of the second part of the description which relates to FIGS. 1 to 5.

1. Device (100, 200, 400, 500), especially input device (100 to 400), comprising a sensor (SEN),
wherein the device (500) comprises a first communication unit (CU1, SPI1, I2C1) and a second communication unit (CU2, SPI2, I2C2) that are adapted for synchronous communication according to a clock signal (SCLK, SCL) generated by the first communication unit (CU1, SPI1, I2C1) or by the second communication unit (CU2, SPI2, I2C2),
wherein the first communication unit (CU1, SPI1, I2C1) is adapted to send digital data (D2 or D2b) to the second communication unit (CU2, SPI2, I2C2),
wherein the digital data (D2 or D2b) comprises data (D2) generated by the sensor (SEN) or processed data (D2b) derived from data (D2) generated by the sensor (SEN),
wherein the first communication unit (CU1, SPI1, I2C1) is adapted to be used as a controlling unit during the transmission of the digital data (D2 or D2b) during a first operation mode of the communication units (CU1, CU2),
wherein the second communication unit (CU2, SPI2, I2C2) is adapted to be used as a controlled unit during the transmission of the digital data (D2 or D2b) during the first operation mode of the communication units (CU1, CU2), and
wherein the controlling unit generates the clock signal (SCLK, SCL) for the controlled unit.

2. Device (100, 200, 400, 500) according to claim 1, wherein the device comprises a processor (P1) that configures the first communication unit (CU1, SPI1, I2C1) and
wherein the processor (P1) is programmed such that the first communication unit (CU1, SPI1, I2C1) is used as the controlling unit (M) during the transmission of the digital data (D2, D2a), preferably during a first operation mode of the device (500), and/or
wherein the device comprises a processor (P2) that configures the second communication unit (CU2, SPI2, I2C2) and wherein the processor (P2) that configures the second communication unit (CU2, SPI2, I2C2) is programmed such that the second communication unit (CU2, SPI1, I2C1) is used as the controlled unit (S) during the transmission of the digital data (D2, D2a), preferably during the first operation mode of the device (500).

3. Device (100, 200, 400, 500) according to one of the preceding claims, wherein the device (500) is an optical input device (100, 200, 400, 500) for detecting input of a user based on movement of the input device (100, 200, 400, 500) relative to a surface (SF), comprising a case (C), an optical unit (OU) that comprises the sensor and an electrical unit (EU),
wherein the optical unit (OU) comprises a radiation source (RS) and the sensor (SEN, SE) arranged within the case (C) or on the case (C),
wherein preferably the elements of the optical unit (OU) are arranged such that radiation (R1) emitted by the radiation sensor (SE) is directed to a surface (SF) on which the case (C) is moved by the user and such that radiation (R1) that is reflected by the surface (SF) is received by the radiation sensor (SE), wherein the electrical unit (EU) comprises the first communication unit (CU1, SPI1, I2C1) and the second communication unit (CU2, SPI2, I2C2) arranged within the case (C),
wherein preferably the digital data (D2 or D2b) comprises data (D2) generated by the radiation sensor (SE) or processed data (D2b) derived from data (D2) generated by the radiation sensor (SE).

4. Device (100, 200, 400, 500) according to one of the preceding claims, wherein the first communication unit (CU1, SPI1, I2C1) comprises a first port adapted to output a clock signal (SCLK, SCL) used for synchronizing the communication between the first communication unit (CU1, SPI1, I2C1) and the second communication unit (CU2, SPI2, I2C2) and wherein the second communication (CU2, SPI2, I2C2) unit comprises a first port electrical connected to the first port of the first communication unit (CU1, SPI1, I2C1) and adapted to receive a clock signal (SCLK, SCL), and/or wherein the first communication unit (CU1, SPI1, I2C1) comprises one or at least one data port adapted to output a data signal used for transmitting the digital data from the first communication unit (CU1, SPI1, I2C1) to the second communication unit (CU2, SPI2, I2C2) and wherein the second communication unit (CU2, SPI2, I2C2) comprises one or at least one data port adapted to receive the output signal.

5. Device (100,200, 500) according to one of the preceding claims, wherein a shift register based communication is used for the communication between the first communication unit (CU1) and the second communication unit (CU2), and/or
wherein data transmission is performed without transmitting an address of the first communication unit (CU1, SPI1) and/or without transmitting an address of the second communication unit (CU2, SPI2),
wherein preferably the communication uses SPI or SSI.

6. Device (400, 500) according to any one of the claims 1 to 4, wherein the first communication unit (CU1, I2C1) and the second communication unit (CU2, I2C2) are part of a serial communication bus,
wherein the first communication unit (CU1, I2C1) has a first address and the second communication unit (CU2, I2C2) has a second address, and
wherein the first communication unit (CU1, I2C1) uses the second address to address the second communication unit (CU2, I2C1), and
wherein preferably the bus is an I2C bus or an I3C bus.

7. Device (200, 400, 500) according to any one of the preceding claims, wherein the device (200, 400, 500) comprises at least one of:
a first direct memory access unit (DMA1) that transfers data from the sensor (SEN, SE) or from a first memory unit (M1) to the first communication unit (CU1, SPI1, I2C1), or
a second direct memory access unit (DMA2) that transfers data from the second communication unit (CU2, SPI2, I2C2) to a second memory unit (M2) or to another unit used to transfer the digital data received via the second communication unit (CU2, SPI2, I2C2).

8. Device (100, 200, 400, 500) according to any one of the preceding claims, wherein the first communication unit (CU1, SPI1, I2C1) is comprised in a first electrical unit (EU1),
wherein the second communication unit (CU2, SPI2, I2C2) is comprised in a second electrical unit (EU2),
wherein a first control port of the first electrical unit (EU1) is adapted to receive a signal (MS, SS) that indicates whether the first communication unit (CU1, SPI1, I2C1) is the controlling (M) unit and/or whether the second communication unit (CU2, SPI2, I2C2) is the controlling (M) unit,
wherein a second control port of the second electrical unit (EU) is adapted to send a signal that indicates whether the first communication unit (CU1, SPI1, I2C1) is the controlling (M) unit and/or whether the second communication (CU2, SPI2, I2C2) unit is the controlling (M) unit, and
wherein the first control port (MS, SS) and the second control port are electrically connected to each other.

9. Device (100 to 500) according to any one of the preceding claims, wherein the first communication unit (CU1, SPI1, I2C1) is adapted to send digital control data (C1) to the second communication unit (CU2, SPI2, I2C2),
wherein the digital control data (C1) sent by the first communication unit (CU1, SPI1, I2C1) or by the second communication unit (CU2, SPI2, I2C2) indicates that the second communication unit (CU2, SPI2, I2C2) has to operate as the controlling (M) unit for further data transfer, and/or
wherein the first communication unit (CU1, SPI1, I2C1) is adapted to receive digital control data from the second communication unit (CU2, SPI2, I2C2),
wherein the digital control data received by the first communication unit (CU1, SPI1, I2C1) indicates that the first communication unit (CU1, SPI1, I2C1) has to operate as the controlling unit (M) for further data transfer.

10. Device (100 to 500) according to any one of the preceding claims, wherein the sensor (SEN) is a radiation sensor (SE),
wherein the device (100 to 500) is adapted such that the digital data (D2) is data generated by the radiation sensor (SE) or by an analog digital converter that is adapted to convert analog output date of sensor (SE) to digital data (D2),
whereby preferably the device (100, 200, 400, 500) is adapted such that for each picture element (PE) of the radiation sensor (SE) corresponding data (D2) is transmitted.

11. Device (100, 200, 400, 500) according to any one of the preceding claims,
wherein the device (100, 200, 400, 500) comprises a first electrical unit (EU1) that comprises at least one first integrated chip (IC1) and a second electrical unit (EU2) that comprises at least one second integrated chip (IC2)

12. Device (100, 200, 400, 500) according to any one of the preceding claims,
wherein the device (100, 200, 400, 500) is an optical input device,
wherein the optical input device (100, 200, 400, 500) comprises at least one of, at least several or all of the following elements:
at least one button, e.g. left mouse button and right mouse button and optional middle button, or
at least one rotatable wheel, and
wherein preferably the sensor (SEN, SE) has less than 10000, less than 2500 or less than 1025 pixels (PE).

13. Device (100, 200, 400, 500) according to any one of the preceding claims,
wherein the device (100, 200, 400, 500) comprises a processing unit (P2) that is adapted to realize a third communication unit, preferably a communication unit that transmits data via a wire, preferably according to the USB standard.

14. Device (100, 200, 400, 500) according to any one of the claims 1 to 12, wherein the device (100, 200, 400, 500) comprises a processing unit (P2) that is adapted to realize a third communication unit, preferably a communication unit that transmits data wireless, preferably according to Bluetooth.

15. Method (300) for changing of the controlling unit for data transmission, especially using a device (100, 200, 400, 500) according to one of the preceding claims,
wherein a first communication unit (CU1, SPI1, I2C1) is defined as the controlling unit during a first operation mode of the communication units (CU1, CU2) and a second communication unit (CU2, SPI2, I2C2) is defined as the controlled unit during the first operation mode of the communication units (CU1, CU2),
wherein the first communication unit (CU1, SPI1, I2C1) and the second communication unit (CU2, SPI2, I2C) are adapted for synchronous communication according to a clock signal (SCLK, SCL) generated by the first communication unit (CU1, SPI1, I2C1) or the second communication unit (CU2, SPI2, I2C2) depending on which one is the controlling unit,
wherein first digital data (D3) is transmitted from the first communication unit (CU1, SPI1, I2C1) to the second communication unit (CU2, SPI2, I2C2) under control of the first communication unit (CU1, SPI1, I2C1),
wherein the digital data (D2 or D2b, D3) comprises data (D2, D3) generated by the sensor (SEN) or processed data (D2b) derived from data (D2, D3) generated by the sensor (SEN),
wherein after the transmission of the first digital data (D3) a control code (C1) is transmitted between the first communication unit (CU1, SPI1, I2C1) and the second communication unit (CU2, SPI2, I2C2) via the same transmission channel as the digital data (D3), wherein the control code (C1) specifies that the second communication unit (SPI2, I2C2) has to be the controlling unit for further data transfer, and wherein after transmission of the control code (C1) second digital data (D4) is transmitted from the second communication unit (SPI2, I2C2) to the first communication unit (SPI1, I2C1) under control of the second communication unit (SP12, I2C2).
